(19) United States
(12) Patent Application Publication
(10) Pub. No.: US 2026/0084464 A1
(43) Pub. Date: Mar. 26, 2026

(54) ADJUSTABLE POSITIONING STRUCTURE OF BEARING OF BICYCLE WHEEL RIM

(71) Applicant: CHUN-HUO LIN, Changhua County (TW)

(72) Inventor: CHUN-HUO LIN, Changhua County (TW)

(21) Appl. No.: 18/893,685

(22) Filed: Sep. 23, 2024

(51) Int. Cl. B60B 21/00

(52) U.S. Cl. CPC B60B 21/00; B60B 2380/70

(57) ABSTRACT

An adjustable positioning structure of a bearing of a bicycle wheel rim contains: a central shaft, two screw nut devices, two bearing caps, two fitting sleeves, two fixers, and two abutting elements. The central shaft includes two threaded portions. Each screw nut device includes two screw nuts for adjusting a length of the central shaft. Each bearing cap includes a through orifice. An internal ring of each fitting sleeve is fitted into each bearing cap. Each fixer is disposed on each fitting sleeve. Each screw nut device is configured to position an internal ring of each fitting sleeve to adjust a working length of the hub. Each abutting element is fixed on each fixer to connect the central shaft, each bearing cap and each fitting sleeve on the hub, thereafter the hub is locked on a bicycle rack or a front fork of a bicycle.

### TECHNICAL FIELD

The present invention relates to a rotatable hub of a bicycle, and more particularly to an adjustable positioning structure of a bearing of a bicycle wheel rim.

### BACKGROUND

A conventional central shaft structure of a hub of a bicycle consists: a central shaft, two ends of which are connected with a bearing cap, a caged bearing, a fixer and a force element.

In use, the caged bearing is fits on the bearing cap and rotates along the central shaft. However, the conventional central shaft structure has following defects:
1) The central shaft has various specifications, and the lengths of the fixer are different, thus having troublesome maintenance.
2) The caged bearing rotates along the bearing cap, so it can be understood that a large amount of lubricating grease (butter) needs to be applied, but maintenance and repair requires scraping off and cleaning the lubricating grease, which is quite troublesome.
3) The positioning needs to be adjusted when the bearing cap and the caged bearing are connected, and it is necessary to avoid being too loose or too tight, which will cause the central shaft and the hub to deviate. Most of the people have no experience in replacement, so only one side of the caged bearing contacts the bearing cap, which causes serious wear and short service life of the caged bearing.

The present invention has arisen to mitigate and/or obviate the afore-described disadvantages.

### SUMMARY

The primary aspect of the present invention is to provide an adjustable positioning structure of a bearing of a bicycle wheel rim which is applicable for hubs of various lengths to reduce a replacement cost of a bearing and to enhance a service life of the bearing.

Secondary aspect of the present invention is to provide an adjustable positioning structure of a bearing of a bicycle wheel rim by which each fitting sleeve is maintained easily without adding lubricating oil, thus facilitating maintenance and prolonging a service life.

Further aspect of the present invention is to provide an adjustable positioning structure of a bearing of a bicycle wheel rim by which each screw nut device is configured to adjust a distance of each fitting sleeve with respect to the central shaft and is applicable for hubs of various widths, thus enhancing a using convenience.

Another aspect of the present invention is to provide an adjustable positioning structure of a bearing of a bicycle wheel rim by which a cost of each fitting sleeve is reduced to avoid an angle skew of a conventional caged bearing and to obtain an easy maintenance.

To obtain above-mentioned aspects, an adjustable positioning structure of a bearing of a bicycle wheel rim provided by the present invention contains: a central shaft, two screw nut devices, two bearing caps, two fitting sleeves, two fixers, and two abutting elements.

The central shaft is a metal rod and includes two threaded portions formed on two ends of the central shaft.

Each screw nut device includes two screw nuts which are connected together, the two screw nuts are screwed with the two threaded portions of the central shaft and located adjacent to an inner wall of the central shaft, and each screw nut device is adjustable to be positioned on the central shaft so as to adjust a length of the central shaft with respect to a length of a hub.

Each bearing cap is circular and includes a through orifice defined on a center of each bearing cap, and the through orifice is configured to connect each bearing cap on each end of two ends of the central shaft.

Each fitting sleeve is mounted on each end of the central shaft, and an internal ring of a side of each fitting sleeve is fitted into an inner wall of each bearing cap so that each fitting sleeve is rotated along the central shaft.

Each fixer is disposed on each fitting sleeve, and each fixer is disposed on the other side of each fitting sleeve.

Each screw nut device is configured to position an internal ring of each fitting sleeve so as to adjust a working length of the hub.

Each abutting element is fixed on an outer wall of each fixer so as to connect the central shaft, each bearing cap and each fitting sleeve on the hub, thereafter the hub is locked on a bicycle rack or a front fork of a bicycle.

### BRIEF DESCRIPTION OF THE DRAWINGS

FIG. 1 is a perspective view showing the assembly of an adjustable positioning structure of a bearing of a bicycle wheel rim according to a preferred embodiment of the present invention.

FIG. 2 is a side plan view showing the assembly of the adjustable positioning structure of the bearing of the bicycle wheel rim according to the preferred embodiment of the present invention.

FIG. 3 is a cross sectional view showing the assembly of the adjustable positioning structure of the bearing of the bicycle wheel rim according to the preferred embodiment of the present invention.

FIG. 4 is a cross sectional view showing the operation of the adjustable positioning structure of the bearing of the bicycle wheel rim according to the preferred embodiment of the present invention.

FIG. 5 is another cross sectional view showing the operation of the adjustable positioning structure of the bearing of the bicycle wheel rim according to the preferred embodiment of the present invention.

### DETAILED DESCRIPTION

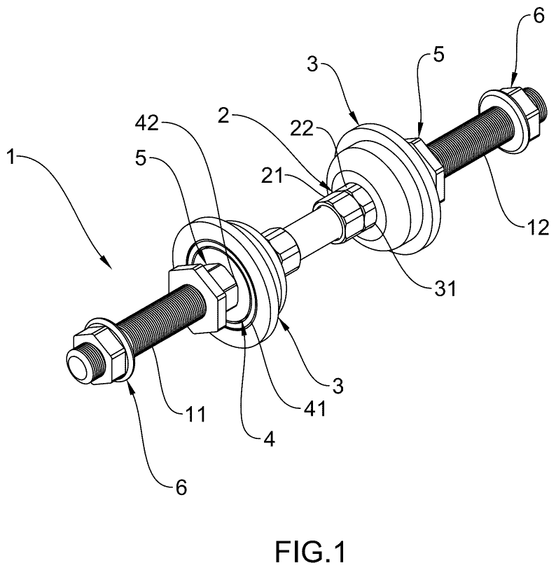

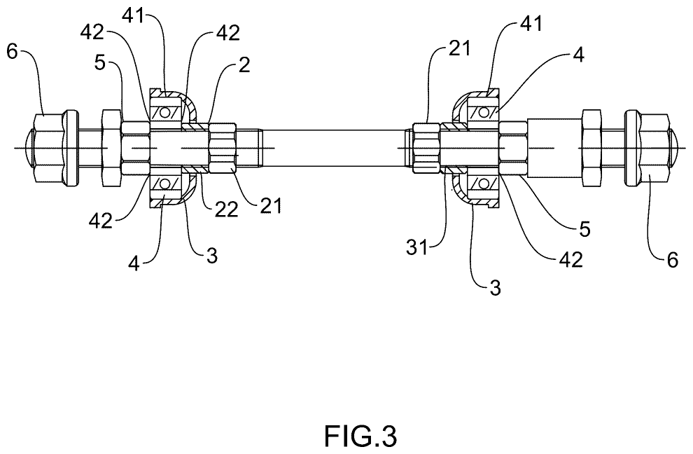

With reference to FIGS. 1-3, an adjustable positioning structure of a bearing of a bicycle wheel rim according to a preferred embodiment of the present invention comprises: a central shaft 1, two screw nut devices 2, two bearing caps 3, two fitting sleeves 4, two fixers 5, and two abutting elements 6.

The central shaft 1 is a metal rod and includes two threaded portions 11, 12 formed on two ends of the central shaft 1.

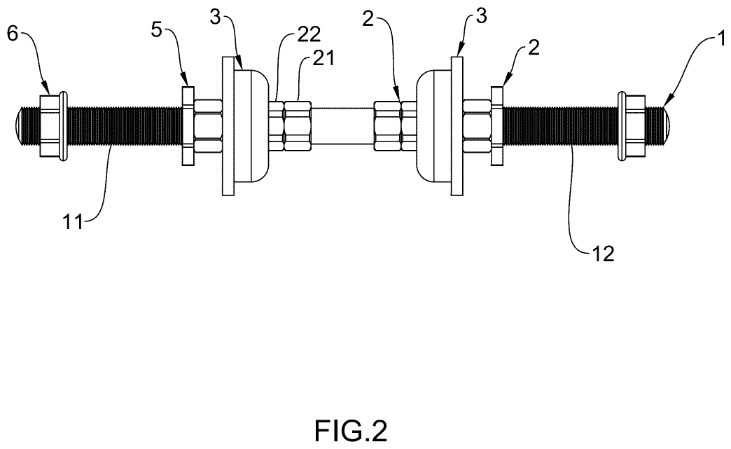

Each screw nut device 2 includes two screw nuts 21, 22 which are connected together, wherein the two screw nuts 21, 22 are screwed with the two threaded portions 11, 12 of the central shaft 1 and are located adjacent to an inner wall of the central shaft 1, as shown in FIGS. 1 and 2.

Each bearing cap 3 is circular and is applicable for a hub hole, wherein each bearing cap 3 includes a through orifice 31 defined on a center thereof and configured to connect each bearing cap 3 on each end of two ends of the central shaft 1, and each bearing cap 3 is fixed by each screw nut device 2.

Each fitting sleeve 4 is mounted on each end of the central shaft 1, and an internal ring 41 of a side of each fitting sleeve 4 is fitted into an inner wall of each bearing cap 3 so that each fitting sleeve 4 is rotated along the central shaft 1.

Each fixer 5 is disposed on each fitting sleeve 4, for example, each fixer 5 is disposed on the other side of each fitting sleeve 4, wherein the fixer 5 is a hexagonal nut.

Each screw nut device 2 is configured to position an inner ring 42 of each fitting sleeve 4 so as to adjust a working length of a hub 7.

Each abutting element 6 is fixed on an outer wall of each fixer 5 so as to connect the central shaft 1, each bearing cap 3 and each fitting sleeve 4 on the hub 7, then the hub 7 is locked on a bicycle rack (not shown) or a front fork (not shown) of a bicycle (not shown).

Preferably, each fitting sleeve 4 is maintained easily without adding lubricating oil, thus facilitating maintenance and prolonging a service life.

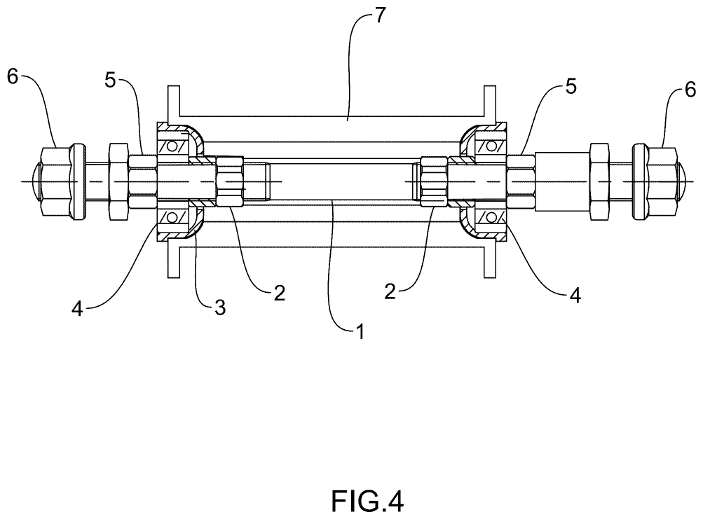

Referring to FIG. 4, each screw nut device 2 is configured to adjust a distance of each fitting sleeve 4 with respect to the central shaft 1 and is applicable for hubs 7 of various widths, thus enhancing a using convenience.

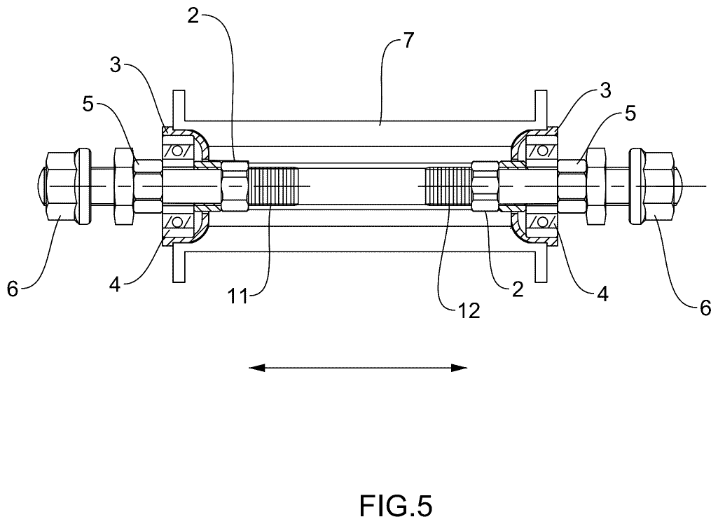

As illustrated in FIG. 5, when the hub 7 has a larger width, each screw nut 2 is moved outward with respect to the central shaft 1, and each bearing cap 3, each fitting sleeve 4, each fixer 5 and each abutting element 6 are screwed on each threaded portion 11 or 12 of the central shaft 1, hence the central shaft 1 is applicable for the hubs 7 of various widths.

In addition, a cost of each fitting sleeve 4 is reduced to avoid an angle skew of a conventional caged bearing and to obtain an easy maintenance.

While the first embodiments of the invention have been set forth for the purpose of disclosure, modifications of the disclosed embodiments of the invention as well as other embodiments thereof may occur to those skilled in the art. The scope of the claims should not be limited by the first embodiments set forth in the examples, but should be given the broadest interpretation consistent with the description as a whole.

What is claimed is:

1. An adjustable positioning structure of a bearing of a bicycle wheel rim comprising:
a central shaft being a metal rod and including two threaded portions formed on two ends of the central shaft;
two screw nut devices, each screw nut device including two screw nuts which are connected together, wherein the two screw nuts are screwed with the two threaded portions of the central shaft and located adjacent to an inner wall of the central shaft, and each screw nut device is adjustable to be positioned on the central shaft so as to adjust a length of the central shaft with respect to a length of a hub;
two bearing caps, each bearing cap being circular and including a through orifice defined on a center of each bearing cap, wherein the through orifice is configured to connect each bearing cap on each end of two ends of the central shaft;
two fitting sleeves, each fitting sleeve being mounted on each end of the central shaft, wherein an internal ring of a side of each fitting sleeve is fitted into an inner wall of each bearing cap so that each fitting sleeve is rotated along the central shaft;
two fixers, each fixer being disposed on each fitting sleeve, wherein each fixer is disposed on the other side of each fitting sleeve;
wherein each screw nut device is configured to position an internal ring of each fitting sleeve so as to adjust a working length of the hub;
two abutting elements, each abutting element is fixed on an outer wall of each fixer so as to connect the central shaft, each bearing cap and each fitting sleeve on the hub, thereafter the hub is locked on a bicycle rack or a front fork of a bicycle.

2. The adjustable positioning structure as claimed in claim 1, wherein the fixer is a hexagonal nut.
